(19) United States
(12) Patent Application Publication
(10) Pub. No.: US 2026/0366995 A1
(43) Pub. Date: Nov. 19, 2026

(54) GAS CONCENTRATION SENSOR AND METHOD OF USING THE SAME

(71) Applicant: MKS INC., Andover, MA (US)

(72) Inventors: Hongke Ye, Andover, MA (US); Steven Ernst, Andover, MA (US); Chenglong Yang, Andover, MA (US); Todd Stacy, Andover, MA (US)

(73) Assignee: MKS INC., Andover, MA (US)

(21) Appl. No.: 19/135,276

(22) PCT Filed: Dec. 8, 2023
(86) PCT No.: PCT/US2023/083040

§ 371 Date: Jun. 3, 2025

Related U.S. Application Data
(60) Provisional application No. 63/432,609, filed on Dec. 14, 2022.

(51) Int. Cl. G01N 21/3504

(52) U.S. Cl. CPC G01N 21/3504; G01N 2201/062; G01N 2201/08

(57) ABSTRACT

An optical gas concentration sensor includes a sample cell comprising an inlet port and an outlet port through which a gas can flow, a light source configured to emit light into an interior of the sample cell, a light detector arranged outside the sample cell, and an optical waveguide assembly optically coupling an interior of the sample cell to the detector. The optical waveguide assembly includes a first optical waveguide coupled to the sample cell, a second optical waveguide coupled to the detector and an optical coupler optically coupling the first optical waveguide to the second optical waveguide. The first optical waveguide has different optical transmission characteristics from the second optical waveguide at wavelengths in a wavelength range from 1.5 μm to 18 μm.

### BACKGROUND

### I. Technical Field

Embodiments of the present invention relate generally to gas concentration measurement and, more particularly, to concentration measurement of a precursor in a carrier gas.

### II. Background

In semiconductor manufacturing processes, various liquid or solid materials are gasified by being heated so as to form material gases, and these material gases are then introduced into a vacuum chamber, e.g., during chemical vapor deposition (CVD) or atomic layer deposition (ALD) processes. Some of these chemical processes utilize optical gas concentration measurement sensors, such as nondispersive infrared (NDIR) gas concentration sensors, to monitor gas concentration.

A typical NDIR gas concentration sensor includes a gas sample cell, an infrared (IR) light source, an IR detector, and an electronic assembly that receives information from the IR detector. The IR light source emits light through the gas sample cell and to the IR detector, and the variation of light transmitted from the IR light source to the IR detector due to the absorption of a sample gas can be used to infer a concentration of the gas within the gas sample cell.

However, high temperature environments, such as those found in many CVD and ALD processes, may significantly limit the lifetime of such NDIR gas concentration sensors, as well as many other types of gas sensors, since many of the electronic components experience dramatically shortened lifetimes when exposed to high temperatures, such as temperatures in excess of 100 °C (e.g., 200 °C, or thereabout). Additionally, the performance stability of conventional IR detectors typically degrades at elevated temperatures, especially at temperatures above 100 °C. Also, electronic components capable of operating at temperatures above 100 °C can be undesirably expensive.

Furthermore, traditional NDIR gas concentration sensors (and other conventional binary gas sensors, such as ultrasound sensors) are susceptible to environmental variation and long term drift factors (e.g., window contamination over time). Also some precursor gases degrade over time, and degradation byproducts cannot be differentiated using from such conventional NDIR or binary gas sensors.

There is therefore a need in the art for a new optical gas concentration sensor that addresses some of the current shortcomings, particularly those involved in measuring concentrations of gases such as precursor gases in high temperature environments.

### SUMMARY

One embodiment of the present invention can be broadly characterized as an optical gas concentration sensor that includes a sample cell comprising an inlet port and an outlet port through which a gas can flow, a light source configured to emit light into an interior of the sample cell, a light detector arranged outside the sample cell and an optical waveguide assembly optically coupling an interior of the sample cell to the detector. The optical waveguide assembly includes a first optical waveguide coupled to the sample cell, a second optical waveguide coupled to the detector and an optical coupler optically coupling the first optical waveguide to the second optical waveguide. The first optical waveguide has different optical transmission characteristics from the second optical waveguide at wavelengths in a wavelength range from 1.5 μm to 18 μm.

### BRIEF DESCRIPTION OF THE DRAWINGS

FIG. 1 illustrates a schematic view of an optical gas concentration sensor according to some embodiments of the present invention.

FIG. 2 illustrates a schematic view of the light source shown in FIG. 1, according to one embodiment of the present invention.

FIGS. 3 and 10 illustrate schematic views of the detector shown in FIG. 1, according to some embodiments of the present invention.

FIG. 4 illustrates a schematic view of filter assembly shown in FIG. 3, according to one embodiment of the present invention.

FIG. 5 illustrates a graph of radiance detectable by the detector shown in FIG. 3 vs. wavelength.

FIG. 6 illustrates a graph of absorption spectra of different materials at different wavelengths.

FIG. 7 illustrates a graph representing the output of a conventional NDIR gas concentration sensor as a function of time.

FIG. 8 illustrates a graph representing the output of the gas concentration sensor shown in FIG. 1 as a function of time.

FIG. 9 illustrates a schematic view of system with which the enclosure shown in FIG. 1 may be incorporated, according to some embodiments of the present invention.

### DETAILED DESCRIPTION

Example embodiments are described herein with reference to the accompanying FIGS. Unless otherwise expressly stated, in the drawings the sizes, positions, etc., of components, features, elements, etc., as well as any distances therebetween, are not necessarily to scale, but are exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa. The section headings used herein are for organizational purposes only and are not to be construed as limiting the subject matter described.

Unless indicated otherwise, the term “about,” “thereabout,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

It will be appreciated that many different forms and embodiments are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

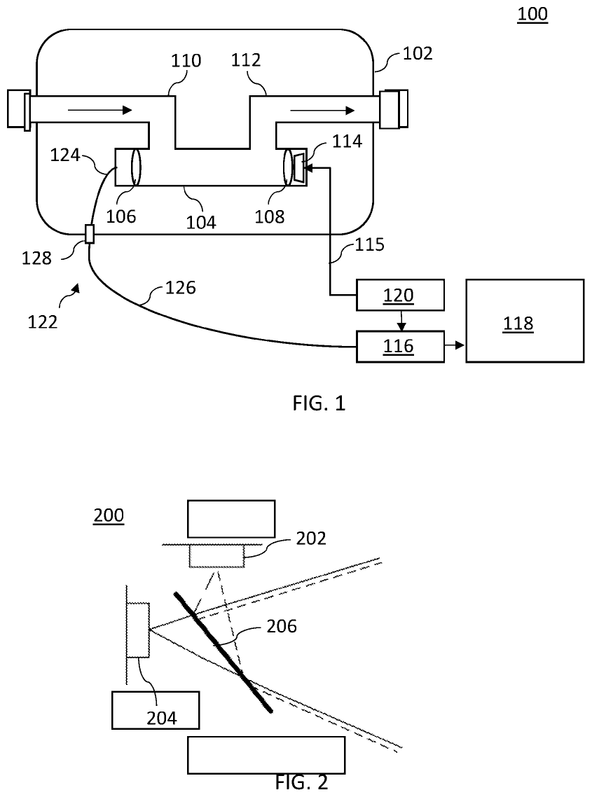

FIG. 1 illustrates a schematic view of an optical gas concentration sensor according to some embodiments of the present invention.

Referring to FIG. 1, an optical gas concentration sensor, such as sensor 100, can be provided within a thermally insulated enclosure 102. The sensor 100 can include a gas sample cell 104 situated within the thermally insulated enclosure 102 and may have one or more optical couplers (e.g., first optical coupler 106 and a second optical coupler 108), and one or more gas flow ports (e.g., an inlet gas flow port 110 and an outlet gas flow port 112).

Constructed as described above, the gas sample cell 104 may be configured to receive a gas, such as a high temperature process gas (e.g., also referred to herein simply as a “gas”, which may be provided as a gas mixture containing a carrier gas and one or more precursor gases), through the inlet gas flow port 110 and expel the gas through the outlet gas flow port 112. When gas is flowing through the sample cell 104, temperatures within the enclosure 102 are typically above 100 °C (e.g., equal to or greater than about 120 °C, 150 °C, 200 °C, 220 °C, etc., or any temperature between these values). Although not illustrated, a temperature control element (e.g., a heater) may be provided (e.g., within the enclosure) to heat the interior of the enclosure 102. Operation of the temperature control element may be controlled by a thermostat (also not shown) to maintain the interior of the enclosure at a constant or substantially constant temperature. Maintaining an at least substantially constant temperature within the enclosure 102 will facilitate consistent operation of the sensor 100.

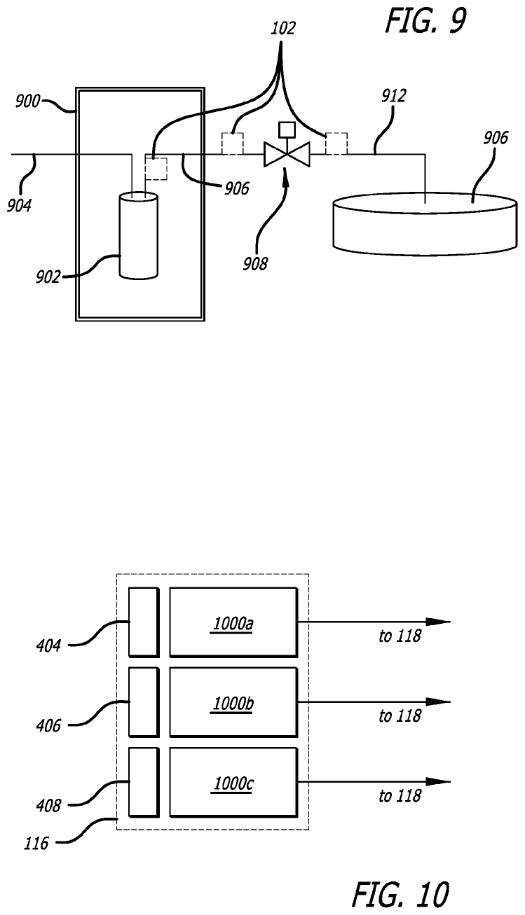

The enclosure 102 may, itself, be provided at any suitable or desired location along a line for delivering precursor gas to a chamber where an CVD or ALD is to be carried out. For example, FIG. 9 schematically illustrates that the enclosure 102 may be provided within a gas cabinet 900, in which a precursor ampoule 902 is located. The precursor ampoule 902 may be provided in any suitable manner known in the art (e.g., the precursor ampoule 902 maybe coupled to a carrier gas input line 904 and a precursor gas outlet line 906). In this case, the enclosure 102 may be arranged so that the gas sample cell 104 is in fluid communication with the precursor gas outline line 906 via the aforementioned inlet gas flow port 110 and outlet gas flow port 112.

Additionally or alternatively, the enclosure 102 may be located outside the gas cabinet 900, at a location upstream of a precursor gas supply switch 908 (e.g., in fluid communication with the precursor gas outlet 906). In this case, the enclosure 102 may be arranged so that the gas sample cell 104 is in fluid communication with the precursor gas outline line 906 via the aforementioned inlet gas flow port 110 and outlet gas flow port 112.

Additionally or alternatively, the enclosure 102 may be located outside the gas cabinet 900, at a location downstream of the precursor gas supply switch 908. For example, the enclosure 102 may be arranged so that the gas sample cell 104 is in fluid communication with a precursor gas supply line 912 via the aforementioned inlet gas flow port 110 and outlet gas flow port 112.

Referring back to FIG. 1, the sensor 100 may also include a light source 114, a light detector 116, an analyzer 118, and a controller 120. The enclosure 102 is constructed from one or more thermally-insulating materials to prevent the transfer of heat from within the interior of the enclosure 102 to regions outside the enclosure 102 (e.g., where the light detector 116, analyzer 118 and controller 120 are located).

The light source 114 may be arranged within the sample cell 104 (e.g., behind the second optical coupler 108) and operative to emit light (in response to one or more power or command signals output by the controller 120 via link 115) into the gas sample cell 104 via the second optical coupler 108. The link 115 can be fed into the interior of the enclosure 102 through a thermally-insulated access port (not shown) formed in a wall of the enclosure 102 by any known or otherwise suitable means. In one embodiment, the controller 120 is configured to operate the light source 114 in a pulsed mode (e.g., in which the light source 114 is strobed or otherwise flashed intermittently), in a continuous mode, or the like or any combination thereof.

Generally, the second optical coupler 108 is configured to direct light emitted by the light source 114 into the sample cell 104. The second optical coupler 108 is sealingly coupled within the sample cell 104 to prevent gas introduced into the sample cell 104 (e.g., via the inlet gas flow port 110) from reaching the light source 114. In one embodiment, the second optical coupler 108 can include a window (e.g., at least substantially transparent to the measurement light) sealingly coupled to the sample cell 104 and a concavely-curved mirror or lens (e.g., configured to focus or collimate light emitted by the light source 114 through the window and into the sample cell 104) arranged between the window and the light source 114. In another embodiment, the second optical coupler 108 can include a lens (e.g., at least substantially transparent to the light emitted by the light source 114) that is sealingly coupled to the sample cell 104 and also configured to focus or collimate the light emitted by the light source 114 into the sample cell 104 (thus eliminating the need for the aforementioned window).

Light emitted by the light source 114 (also referred to herein as “measurement light”) has one or more wavelengths in a range from 1.5 μm (or thereabout) to 18 μm (or thereabout). This range of wavelengths can be understood to occupy the mid-infrared (IR) range of the electromagnetic spectrum. The light source 114 is provided as a high brightness mid-IR source to overcome the light attenuations by mid-IR optical waveguides to reach a high light flux at the detector, which will lead to a high concentration measurement sensitivity. For typical blackbody emitters (also known as thermal light sources), such as globars (also known in the art as “glowbars”), the emitter temperature needs to be greater than 1500 °C.

In one embodiment, the light source 114 is provided as a thermal light source (e.g., black body emitter) operative to emit the measurement light at temperatures above 1500 °C (e.g., greater than or equal to 1600 °C, 1700 °C, 1800 °C, etc., or between any of these values). The thermal light source may thus include one or more radiative elements formed of a material such as silicon, silicon carbide, chrome-nickel alloy, tungsten, ceramics, or the like or any combination thereof. To obtain a meaningful operational lifetime of the thermal light source, the however, the radiative element(s) are hermetically sealed (e.g., to prevent or otherwise minimize corrosion or oxidation of the radiative element(s)).

In another embodiment, the light source 114 is provided as one or more mid-IR light emitting diodes (LEDs). Generally, light emitted by mid-IR LEDs is less bright than light emitted by thermal light sources such as those described above when the LEDs are operated in continuous wave mode. However, when operated in a pulsed mode, there are some benefits to using LED-based light sources. When operated in pulsed mode, an LED can emit light at a very high power and, if placed on a thermoelectric cooler, the output light level can be more stable than conventional black body emitters. In addition, LEDs consume less power and are more compact than better fit to a more compact design than conventional black body emitters. In this embodiment, the light source 114 is provided as one or more mid-IR LEDs the LEDs having an emission spectrums covering the 1-8 μm wavelength range of the electromagnetic spectrum.

Alternatively, the light source 114 may be provided as a plurality of mid-IR LEDs having different, overlapping emission spectrums within the mid-IR wavelength range of the electromagnetic spectrum. For example, the light source 114 may be provided as light source 200 shown in FIG. 2, which includes a first LED 202 (e.g., emitting light in a first mid-IR wavelength range), a second LED 204 (e.g., emitting light in a second mid-IR wavelength range that overlaps the first mid-IR wavelength range) and a beam splitter 206 (e.g., a dichroic beam splitter, a 50/50 beam splitter, etc.) to arranged to combine the optical emission output by the first LED 202 and the second LED 204.

In another example, the light source 114 may be provided as one or more LEDs (e.g., the aforementioned first LED 202 and second LED 204) mounted onto a common substrate (e.g., a PCB) and arranged close to one another so that they may emit light into a common delivery fiber (e.g., a multimode large core, large NA optical fiber) in a manner that light emitted by the LEDs is injected into the core of the delivery fiber. Optionally, one or more lenses or curved mirrors may be arranged between the LEDs and the delivery fiber to condense the light emitted by the LEDs onto the core of the delivery fiber. In either case the precise location of the core can be aligned to capture either equal amounts of power from the LEDs, or can be aligned to capture more light from one LED than the other, depending on the spectral needs of the sensor 100.

Because the core size of the delivery fiber limits the amount of light that can be coupled, the LEDs should be as close as possible. Therefore, it can be desirable to use LEDs capable of emitting light out to the edge of their respective emitting surfaces.

Referring back to FIG. 1, the light detector 116 is optically coupled to the sample cell 104 via an optical waveguide assembly 122, so as to be in optical communication with the interior of the sample cell 104 (e.g., behind the first optical coupler 106). Generally, the first optical coupler 106 is configured to direct the measurement light emitted by the light source 114 and transmitted through the second optical coupler 108 and gas within sample cell 104 into the optical waveguide assembly 122. The first optical coupler 106 is sealingly coupled to the sample cell 104 prevent gas introduced into the sample cell 104 (e.g., via the inlet gas flow port 110) from reaching the optical waveguide assembly 122. In one embodiment, the first optical coupler 106 can include a window (e.g., at least substantially transparent to the measurement light) sealingly coupled to the sample cell 104 and a concavely-curved mirror or lens (e.g., configured to focus the measurement light transmitted through the window onto a first end of the optical waveguide assembly 122) arranged between the window and the optical waveguide assembly 122. In another embodiment, the first optical coupler 106 can include a lens (e.g., at least substantially transparent to the measurement light) that is sealingly coupled to the sample cell 104 and also configured to focus the measurement light transmitted through the sample cell 104 onto the first end of the optical waveguide assembly 122 (thus eliminating the need for the aforementioned window).

The optical waveguide assembly 122 can include a first optical waveguide 124 and a second optical waveguide 126, each configured to transmit the measurement light. The first optical waveguide 124 is optically coupled to the second optical waveguide 126 (e.g., by means of an optical connector 128). Accordingly, a first end of the first optical waveguide 124 (i.e., the aforementioned first end of the optical waveguide assembly 122) can be connected to the sample cell 104 (e.g., at a location behind the first optical coupler 106) and a first end of the second optical waveguide 126 can be connected to the detector 116. Second ends of each of the first optical waveguide 124 and the second optical waveguide 126 can be connected to the optical connector 128 in a manner that the first optical waveguide 124 and the second optical waveguide 126 are in optical communication with each other. Generally, optical connector 128 may be provided as any known or otherwise suitable connector configured to place the first optical waveguide 124 and the second optical waveguide 126 in optical communication with each other when the two waveguides are connected thereto. In addition, the optical connector 128 is mounted to the enclosure 102 at an opening (not shown) therein.

The first optical waveguide 124 is arranged within the enclosure 102 and is provided to maintain suitable optical characteristics (e.g., to maintain acceptably high transmission of the measurement light) and mechanical characteristics (e.g., have suitably high glass transition temperature) at the elevated temperature within the enclosure 102. Examples of waveguides that may be used as the first optical waveguide 124 include optical waveguides (e.g., an optical fiber, a bundle of optical fibers, etc.) including ZrF₄ fiber (e.g., ZBLAN, etc.), indium fluoride (e.g., InF₃) fiber, chalcogenide infrared (CIR) fiber (e.g., As₂S₃ core/AsS cladding), polycrystalline infrared (PIR) fiber (e.g., silver halide PIR fiber), hollow core fiber, or the like or any combination thereof.

The second optical waveguide 126 may be provided as any optical waveguide (e.g., an optical fiber, a bundle of optical fibers, etc.) capable of suitably transmitting the measurement light at lower temperatures (e.g., at temperatures in the ambient environment within the vicinity of the exterior of the enclosure 102). In one embodiment, the second optical waveguide 126 has a higher optical transmission of the measurement light than the first optical waveguide 124; however, the first optical waveguide 124 is shorter in length than the second optical waveguide 126. Accordingly, the difference in optical transmission losses between the first optical waveguide 124 and the second optical waveguide 126 can be minimized or otherwise reduced. Generally, the first optical waveguide 124 will be only as long as necessary to be connected between the sample cell 104 and the enclosure 102. Typically, the first optical waveguide 124 will have a length that is less than or equal to 60 cm (e.g., less than or equal to 55 cm, 40 cm, 30 cm, 20 cm, 10 cm, 5 cm, etc., or between any of these values). The second optical waveguide 126 can have a length greater than any of the aforementioned lengths of the first optical waveguide 124 (e.g., may have a length of up to one meter or more).

Although the optical waveguide assembly 122 has been described above as including two optical waveguides, it will be appreciated that the optical waveguide assembly 122 may include more than two optical waveguides optically connected to each other, or may include a single optical waveguide (e.g., provided as described above with respect to the first optical waveguide 124).

Generally, the detector 116 is operative to generate and output a detection signal to the analyzer 118 when measurement light transmitted by the optical waveguide assembly 122 is incident upon it (e.g., at an active area thereof), wherein the detection signal represents the amount of light detected at the detector 116. In embodiments in which the light source 114 is operated in a pulsed mode (e.g., as described above), then the detector 116 may be provided as an InAsSb or MCT-type detector. Furthermore, in embodiments in which the light source 114 is operated in a pulsed mode (e.g., as described above), the detector 116 may be operated (e.g., in response to one or more control signals output by the controller 120) in synchrony with the pulsed mode operation of the light source 114 to optimize the SNR of the detection signal.

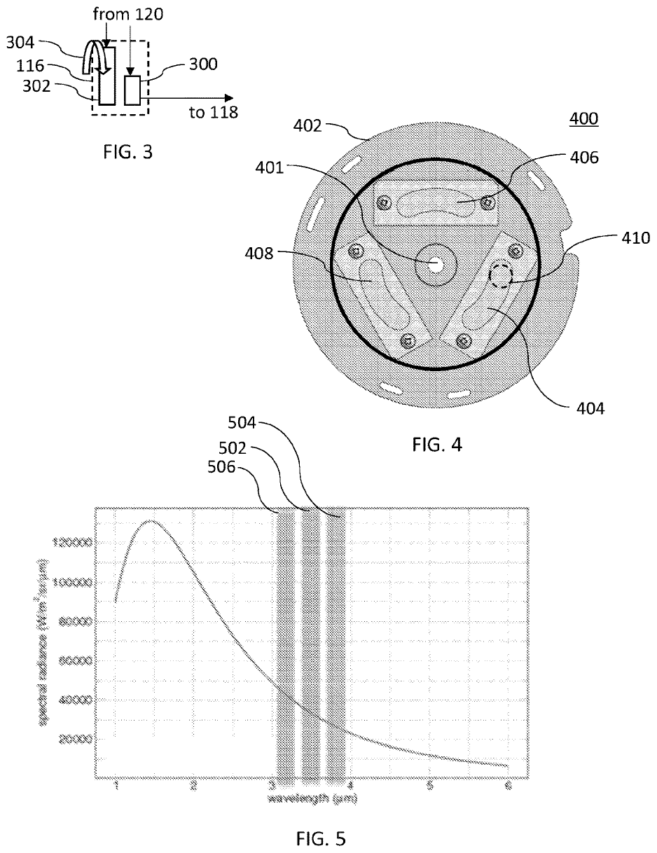

As exemplarily illustrated in FIG. 3, the detector 116 may include a photodetector 300 and a filter assembly 302. The photodetector 300 is sensitive to mid-IR light and is operative to generate and output the detection signal as discussed above. The filter assembly 302 includes a plurality of optical filters that are each configured to transmit a different wavelength band, and is arranged in front of the active area of the photodetector 300 (i.e., the region of the photodetector 300 that converts photons into electrical current). Accordingly, measurement light transmitted by the optical waveguide assembly 122 will be transmitted by an optical filter of the filter assembly 302 before propagating to the photodetector 300. In one embodiment, the filter assembly 302 can be provided as a filter assembly that is moveable (e.g., rotatable, as indicated by arrow 304, etc.) relative to the photodetector 300 so as to selectively arrange a single filter in front of the active area of the photodetector 300. It should be appreciated that the detector 116 may, therefore, include a motor and appropriate mechanical linkages to effect movement of the filter assembly 306, as is known in the art. Although not illustrated, an optional focusing lens may be arranged between the optical waveguide assembly 122 and the filter assembly 302 and be configured to focus the measurement light exiting the optical waveguide assembly 122 (e.g., to a location at or near the filter assembly 302 or the active area of the photodetector 300).

FIG. 4 illustrates an example embodiment of the filter assembly 302. Referring to FIG. 4, the filter assembly 302 may be provided as a filter wheel 400 having a wheel body 402 (e.g., which may include an axle bore 401, etc.) and a plurality of windows defined therein. Affixed to each window is an optical filter configured to transmit a particular wavelength band. For example, the wheel body 402 is illustrated as including a first optical filter 404, a second optical filter 406 and a third optical filter 408, each affixed to a respective window formed in the wheel body 402. The first optical filter 404 may be configured to transmit a first wavelength band, the second optical filter 406 may be configured to transmit a second wavelength band, and the third optical filter 408 may be configured to transmit a third wavelength band. The dashed circle 410 represents the measurement light transmitted by the optical waveguide assembly 122 and incident upon the filter assembly 302 (e.g., at an optical filter, such as the first optical filter 404, as exemplarily shown in FIG. 4) along an axis that is that is perpendicular to the optical filter.

Generally, a center wavelength of the first wavelength band is between a center wavelength of the second wavelength band and a center wavelength of the third wavelength band. Furthermore, the first wavelength band does not overlap or adjoin the second wavelength band or the third wavelength band. See, e.g., the graph 500 of radiance detectable by the detector 300 vs. wavelength in FIG. 5, in which the first wavelength band (also referred to herein as a “signal band”) is identified at 502, the second wavelength band (also referred to herein as a “first reference band”) is identified at 504 and the third wavelength band (also referred to herein as a “second reference band”) is identified at 506. In other embodiments, however, the first wavelength band 502 may adjoin the second wavelength band 504 and/or the third wavelength band 506.

As exemplarily illustrated in FIG. 5, the first wavelength band 502 may cover a wavelength range from 3.42 μm (or thereabout) to 3.65 μm (or thereabout), the second wavelength band 504 may cover a wavelength range from 3.8 μm (or thereabout) to 4.00 μm (or thereabout) and the third wavelength band 506 may cover a wavelength range from 3.2 μm (or thereabout) to 3.3 μm (or thereabout). It will be appreciated, however, that the ranges of the first, second and third wavelength bands may be selected based upon the precursor gas(es) to be monitored, any degraded byproducts of the precursor gas(es) that may be present within the sample cell 104, contaminants that may accumulate on the first optical coupler 106 or second optical coupler 108, variation in the emission spectrum of the light source 114 that may be expected to occur, variation in the transmission spectrum of the optical waveguide assembly 122 that may be expected to occur, variation in detection spectrum of the detector 116 that may be expected to occur, or the like or any combination thereof.

The emission spectrum of the light source 114 may change due to one or more factors such as the temperature of the light source 114 (e.g., if the light source 114 is provided as a thermal light source), the age of the light source 114 (e.g., if the light source 114 is provided as a an LED), or the like or any combination thereof. The transmission spectrum of the optical waveguide assembly 122 may change due to one or more factors such as a temperature change in one or more components of the optical waveguide assembly 122 (e.g., of the first optical waveguide 124 and/or the second optical waveguide 126), movement of one or more components of the optical waveguide assembly 122 (e.g., flexing of the first optical waveguide 124 and/or the second optical waveguide 126), the presence of contaminants that may accumulate on optical surfaces of the optical waveguide assembly 122, or the like or any combination thereof. The detection spectrum of the detector 116 may change due to one or more factors such as a temperature change in the detector 116,), the presence of contaminants that may accumulate on the active area of the detector 116, the age of the detector 116, or the like or any combination thereof.

Generally, however, the ranges of the first, second and third wavelength bands should fall within the mid-IR range of the electromagnetic spectrum as the majority of precursors used in the semiconductor industry have strong absorption between 2 to 7 μm. Variation in the emission spectrum of the light source 114, variation in the transmission spectrum of the optical waveguide assembly 122 and variation in detection spectrum of the detector 116 can be generically and/or collectively referred to as “baseline variation.”

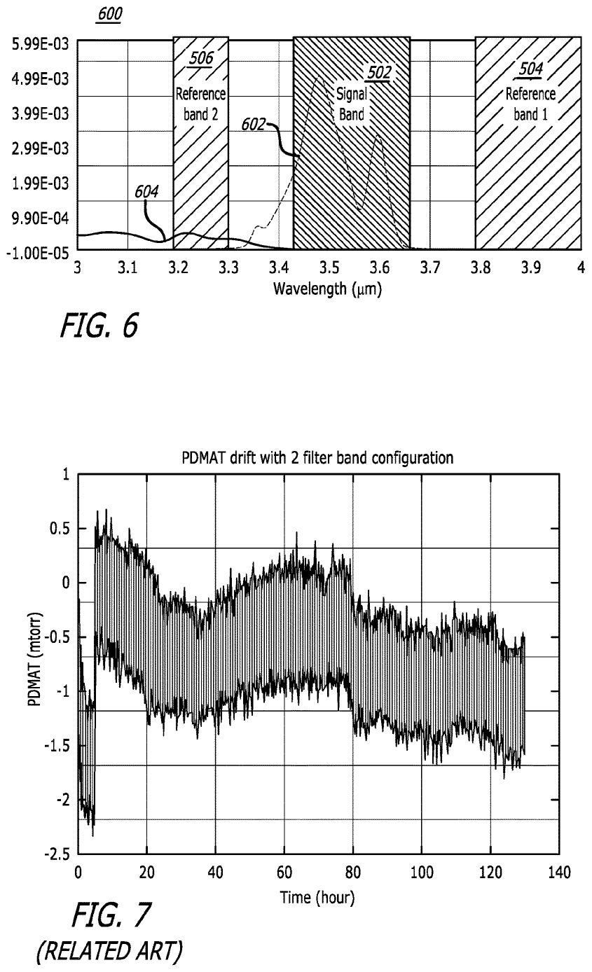

For example, FIG. 6 illustrates a graph 600 of the absorption spectra of various materials at different wavelengths. In particular, line 602 represents the absorption spectrum of an exemplary precursor gas that is measurable by the optical gas concentration sensor 100 and line 604 represents the absorption spectrum of a degraded byproduct and/or a contaminant on an optical coupler of the sample cell 104. In this example, the signal band 502 is selected to cover a wavelength band where the exemplary precursor gas exhibits strong absorption. The second reference band 506 is selected to cover a wavelength band where expected degraded byproducts or contaminants exhibit strong absorption. The first reference band 504 is selected to cover a wavelength band where baseline variation can be detected (e.g., in regions of the wavelength spectrum where the exemplary precursor gas and expected degraded byproducts and contaminants do not exhibit strong wavelength absorption).

When the first optical filter 404 (i.e., the optical filter configured to transmit the signal band) is arranged in front of the active area of the photodetector 300, the detection signal generated by the detector 116 can be referred to as a “signal detection signal.” Likewise, when the second optical filter 406 (i.e., the optical filter configured to transmit the first reference band) is arranged in front of the active area of the photodetector 300, the detection signal generated by the detector 116 can be referred to as a “first reference detection signal,” when the third optical filter 408 (i.e., the optical filter configured to transmit the second reference band) is arranged in front of the active area of the photodetector 300, the detection signal generated by the detector 116 can be referred to as a “second reference detection signal.” Accordingly, in order to generate and output the signal detection signal, the first reference detection signal and the second reference detection signal, the filter wheel 400 of the detector 116 may be rotated (e.g., as discussed above) one revolution. It will be appreciated that the filter wheel 400 may be rotated by multiple revolutions to repeatedly generate and output the aforementioned signals.

As an alternative to the embodiment of the detector 116 discussed with respect to FIGS. 3 and 4, the detector 116 may be provided as exemplarily shown in FIG. 10, and include a plurality of photodetectors (e.g., first photodetector 1000a, second photodetector 1000b and third photodetector 1000c, each generically referred to as a photodetector 1000) and a corresponding filter of a plurality of filters arranged in front of the active area of a respective photodetector 1000. For example, the aforementioned first optical filter 404, second optical filter 406 and third optical filter 408 may be arranged in front of the active area of the first photodetector 1000a, second photodetector 1000b and third photodetector 1000c, respectively. Although not illustrated, an optional focusing lens may be arranged between the optical waveguide assembly 122 and the detector 116 and be configured to focus the measurement light exiting the optical waveguide assembly 122 (e.g., to a location at or near the filter assembly 302 or the active area of the photodetector 300) in such a manner that the first optical filter 404, second optical filter 406 and third optical filter 408 are simultaneously illuminated by the measurement light. Constructed as described above, the detector 116 shown in FIG. 10 is capable of generating the aforementioned signal detection signal, first reference detection signal and second reference detection signal simultaneously, and may output such signals to the analyzer 118.

The analyzer 118 is communicatively coupled to the output of the detector 116 (e.g., to receive the detection signal output from the detector 116). Generally, the analyzer 118 is configured to determine or otherwise infer a concentration of precursor gas received into the gas sample cell 104 based on the detection signals output by the detector 116. In one embodiment, the concentration of the precursor gas can be determined or otherwise inferred by calculating the relative difference between the value encoded by the signal detection signal (i.e., a “signal band value”) and the values encoded by the first and second reference detection signals (i.e., a “first reference band value” and “second reference band value”). For example, the detection signal output from the detector 116 can be considered as a vector where different absorption spectra from different molecules in the precursor gas correspond to different absorption vectors; and spectroscopy tools such as classical least square (CLS), partial least square (PLS), Deep Learning, or the like, can be used to distinguish and quantify the composition of the precursor gas. In another example, the concentration, CP, of precursor gas in the sample cell 104 can be determined or otherwise according to the following formula [1];

C_{P}=−a1*log(signal band value)+(a2*log(first reference band value)+a3*log(second reference band value)),

where, a1, a2 and a3 are calibration parameters.

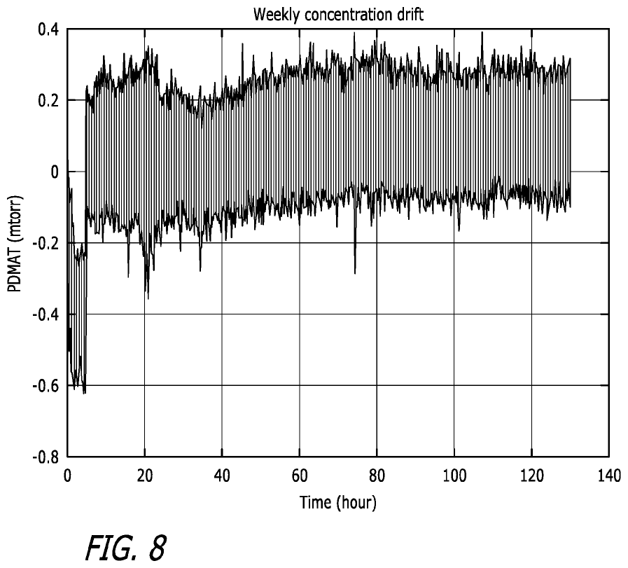

An advantage of using three optical filters, each having three different wavelength bands, as compared to conventional techniques which only use two optical filters to provide only two wavelength bands (i.e., a signal band and a single reference band) can be appreciated by referring to FIG. 7 (illustrating an example of sensor drift present when using only a signal band and a single reference band) and 8 (illustrating an example of sensor drift present when using a signal band and two reference bands). FIGS. 7 and 8, illustrate the variation over time of the concentration of a precursor gas PDMAT within a gas mixture over time (although the y-axis of these graphs indicates partial pressure, it will be understood by those of ordinary skill, that the partial pressure of a particular gas within a gas mixture is proportional to the concentration of the particular gas within the mixture). In FIG. 7, the output of a conventional NDIR gas concentration sensor using only two wavelength bands (i.e., a signal band and a single reference band) varies over time because evidence of the aforementioned baseline variation cannot be accurately detected over time using the signal band and single reference band. However, by employing the sensor 100 having two reference bands, in accordance with the principles of the present invention, baseline variation can be detected (e.g., at the analyzer 118) and compensated to eliminate or otherwise reduce drift in the readings of the sensor 100 (i.e., that are attributable to baseline variation) over time, e.g., as shown in FIG. 8.

Generally, the analyzer 118 can detect baseline variation by: 1) processing the reference detection signals output by the detector 116 to determine a measured relationship between the reference band values encoded by the output reference detection signals; and 2) comparing the measured relationship with a predetermined calibration relationship to determine a difference. If a difference exists (or if the difference is greater than some predetermined threshold), then baseline variation can be considered to have been detected and the analyzer 118 can compensate (e.g., eliminate or otherwise reduce) for the baseline variation. In one embodiment, the analyzer 118 compensates for the baseline variation by scaling the first and second reference band values (e.g., by tuning/varying the aforementioned calibration parameters a2 and a3, respectively) in a manner that minimizes or otherwise reduces the difference between the measured relationship and the calibration relationship and then adjusts the aforementioned calibration parameter a1 accordingly, using any technique that is suitable or known in the art

For example, in the embodiment discussed above, the sensor 100 is configured to generate reference detection signals for two distinct reference bands. So, the analyzer 118 may process the first and second reference detection signals output by the detector 116 (e.g., by performing a linear regression on the first and second reference band values, using any suitable technique known in the art) and compensate for any baseline variation (e.g., by tuning/varying the aforementioned calibration parameters a2 and a3, respectively) in a manner that minimizes or otherwise reduces the difference between the measured relationship and the calibration relationship. The analyzer 118 may then adjust the aforementioned calibration parameter al accordingly, using any technique that is suitable or known in the art.

Although embodiments have been discussed above in which three optical filters are used to determine the concentration of precursor gas within the sample cell 104, it will be appreciated that more than three filters (and, thus, more than three wavelength bands) can be used to create more measurements, which will improve the robustness and accuracy with which the concentration of the precursor gas can be determined. For example, the use of two reference bands as described above can be useful in removing or otherwise reducing baseline variation that is linear in nature (e.g., baseline variation which occurs as a result of change in emitter temperature). However, if the baseline variation is not linear (i.e., if higher-order factors exist), then three or more reference bands can be used (e.g., so a higher order polynomial regression can be used to remove/reduce the higher-order baseline variation). In addition, if the gas flow within the sample cell 104 contain multiple chemicals (e.g., precursor gas and a degraded by-product of the precursor gas), and if these chemicals have overlapping absorption features, then more signal bands can be provided to separate the readings of each of the chemicals.

Generally, the controller 120 includes one or more processors operative to generate the control signals (e.g., upon executing instructions or otherwise). A processor can be provided as one or more general purpose computer processors, microprocessors, digital signal processors, or any other suitable form of circuitry including programmable logic devices (PLDs), field-programmable gate arrays (FPGAs), field-programmable object arrays (FPOAs), application-specific integrated circuits (ASICs)—including digital, analog and mixed analog/digital circuitry—or the like, or any combination thereof, which are operative to execute the instructions or otherwise generate control signals. Execution of instructions can be performed on one processor, distributed among processors, made parallel across processors within a device or across a network of devices, or the like or any combination thereof. Controllers described herein can include tangible media such as computer memory, which is accessible (e.g., via one or more wired or wireless communications links) by a processor. As used herein, computer memory (or, more simply, “memory”) includes magnetic media (e.g., magnetic tape, hard disk drive, etc.), optical discs, volatile or non-volatile semiconductor memory (e.g., RAM, ROM, NAND-type flash memory, NOR-type flash memory, SONOS memory, etc.), etc., and may be accessed locally, remotely (e.g., across a network), or a combination thereof. Generally, the aforementioned instructions may be stored as computer software (e.g., executable code, files, instructions, etc., library files, etc.), which can be readily authored by artisans, from the descriptions provided herein, e.g., written in C, C++, Visual Basic, Java, Python, Tel, Perl, Scheme, Ruby, assembly language, hardware description language (e.g., VHDL, VERILOG, etc.), etc. Computer software is commonly stored in one or more data structures conveyed by computer memory.

Embodiments of the present invention, as described above, provide many advantages over conventional gas concentration sensors. For example, the optical waveguide assembly 122 allow the sample cell 104 to be mechanically decoupled from the rest of the sensor 100 (e.g., the detector 116, analyzer 118 and controller 120). As a result, the sample cell 104 can be compact and easily fit within the enclosure 102 while the detector 116, analyzer 118 and controller 120 can be safely located outside of the enclosure 102 (e.g., at room temperature). Use of a hermetically sealed high temperature blackbody emitter or other high brightness light source 114 and fast-speed detector 116 can optimize SNR performance of the sensor 100. Spectroscopy techniques are used to improve the stability of the sensor 100; without such spectroscopy techniques, the variation of the transmission spectrum via optical fibers would significantly compromise the accuracy and stability of the gas concentration measurement.

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. For example, although the sensor 100 has been described above as having a single-pass sample cell configuration (i.e., in which the measurement light traverses the length of the sample cell a single time), it will be appreciated that the sensor 100 may having multi-pass sample cell configuration (i.e., in which one or more mirrors are disposed within the sample cell 104 to increase the optical pathlength of measurement light within the sample cell, as is known in the art). In another example, the optical filter of the detector 116 may be provided as a MEMS-based Fabre-Perot filter. In yet another example, the detector 116 may include a photodetector arrange the optical output of the optical waveguide assembly 122 (e.g., as descried above) but an angle-tunable optical filter may be arranged within the sample cell 104 to filter light emitted by the light source 114 (e.g., in the manner described in U.S. Pat. No. 9,651,422, which is incorporated herein by reference in its entirety). In another example, although the detector 116 has been shown as being optically coupled to the interior of the sample cell 104 via the optical waveguide assembly 122, the optical waveguide assembly 122 could be omitted and the detector 116 could be mounted directly to the sample cell 104 so as to be in optical communication with the interior thereof. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. An optical gas concentration sensor, comprising:
a sample cell comprising an inlet port and an outlet port through which a gas can flow;
a light source configured to emit light into an interior of the sample cell;
a light detector arranged outside the sample cell; and
an optical waveguide assembly optically coupling an interior of the sample cell to the detector, wherein the optical waveguide assembly includes:
a first optical waveguide coupled to the sample cell;
a second optical waveguide coupled to the detector; and
an optical coupler optically coupling the first optical waveguide to the second optical waveguide,
wherein the first optical waveguide has different optical transmission characteristics from the second optical waveguide at wavelengths in a wavelength range from 1.5 μm to 18 μm.

2. The optical gas concentration sensor of claim 1, further comprising a thermally insulating enclosure, wherein the sample cell is arranged within the thermally insulating enclosure.

3. The optical gas concentration sensor of claim 2, wherein the optical coupled is connected to the thermally insulating enclosure.

4. The optical gas concentration sensor of claim 1, wherein a length of the first optical waveguide is less than a length of the second optical waveguide.

5. The optical gas concentration sensor of claim 1, wherein the first optical waveguide includes at least one optical fiber.

6. The optical gas concentration sensor of claim 1, wherein the first optical waveguide includes a material selected from the group consisting of ZrF₄, InF₃, a chalcogenide material, and a silver halide material.

7. The optical gas concentration sensor of claim 1, wherein the light detector includes:
at least one photodetector; and
a plurality of optical filters arranged and configured to transmit, to the at least one photodetector, different bands of wavelengths in the mid-IR range of the electromagnetic spectrum.

8. The optical gas concentration sensor of claim 7, wherein the at least one photodetector includes a single photodetector.

9. The optical gas concentration sensor of claim 7, wherein the at least one photodetector includes a plurality of photodetectors.

10. The optical gas concentration sensor of claim 9, wherein different optical filters of the plurality of optical filters are arranged at different photodetectors of the plurality of photodetectors.

11. The optical gas concentration sensor of claim 7, wherein the plurality of optical filters includes:
a first optical filter configured to transmit a first band of wavelengths in the wavelength range of the electromagnetic spectrum;
a second optical filter configured to transmit a second band of wavelengths in the wavelength range of the electromagnetic spectrum; and
a third optical filter configured to transmit a third band of wavelengths in the wavelength range of the electromagnetic spectrum,
wherein the first band of wavelengths do not overlap with the third band of wavelengths.

12. The optical gas concentration sensor of claim 11, wherein the second band of wavelengths does not overlap with the first or third bands of wavelengths.

13. The optical gas concentration sensor of claim 11, wherein the second band of wavelengths lies in between the first and third bands of wavelengths.

14. The optical gas concentration sensor of claim 11, wherein wavelengths in the second band of wavelengths are more strongly absorbable by the gas than wavelengths in the first or third bands of wavelengths.

15. The optical gas concentration sensor of claim 14, wherein wavelengths in the first band of wavelengths are more strongly absorbable by byproducts of the gas or contamination within the sample cell than wavelengths in the second or third bands of wavelengths.

16. The optical gas concentration sensor of claim 15, wherein wavelengths in the third band of wavelengths are less strongly absorbable by the gas, byproducts of the gas or contamination within the sample cell than wavelengths in the first or second bands of wavelengths.

17. The optical gas concentration sensor of claim 11, further comprising an analyzer coupled to an output of the detector and configured to determine a concentration of the gas in the sample cell based on detection signals output by the at least one photodetector in response to receiving light transmitted by the first, second and third optical filters.

18. The optical gas concentration sensor of claim 1, further comprising an analyzer coupled to an output of the detector and configured to determine a concentration of the gas in the sample cell.
